(19) United States
(12) Patent Application Publication
(10) Pub. No.: US 2022/0036787 A1
(43) Pub. Date: Feb. 3, 2022

(54) SCANNING MODIFICATION METHOD AND DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Qianqian LIU, Beijing (CN); Chuanyan LAN, Beijing (CN); Xin BI, Beijing (CN)

(21) Appl. No.: 17/212,431

(22) Filed: Mar. 25, 2021

(30) Foreign Application Priority Data
Jul. 30, 2020 (CN) 202010751714.1

(51) Int. Cl. G09G 3/20

(52) U.S. Cl. CPC G09G 3/20; G09G 2300/0443; G09G 2300/0404

(57) ABSTRACT

This application discloses a scanning modification method for modifying an offset between a display panel and a cover plate and a display device. A scanning modification method of a display panel includes: determining a scanning reference point according to an offset angle, which offset angle refers to an alignment offset angle between the cover plate and the display panel; determining a scanning unit and the distribution of individual scanning units in a redefined scanning line according to the offset angle and the size of sub-pixel units, which scanning unit includes at least one sub-pixel unit; determining the starting point of each redefined scanning line according to the offset angle and the size of sub-pixel units; and performing scan display according to the scanning reference point, the distribution of the scanning units and the starting point of the redefined scanning line that are determined.

### CROSS REFERENCE TO RELATED APPLICATIONS

The present application claims the benefit of Chinese Patent Application No. 202010751714.1, filed on Jul. 30, 2020, the entire disclosure of which is incorporated herein by reference.

### TECHNICAL FIELD

The disclosure generally relates to the field of display technology, and in particular, to a scanning modification method and a display device.

### BACKGROUND

With the continuous development of wearable products, the types required for display devices become more and more, and cover plates of various appearances are also constantly changing and developing in order to meet the needs of customers.

### SUMMARY

According to a first aspect, there is provided a scanning modification method for modifying an offset between a display panel and a cover plate, wherein the method includes:

determining a scanning reference point according to an offset angle, which offset angle refers to an alignment offset angle between the cover plate and the display panel;

determining a scanning unit and the distribution of individual scanning units in a redefined scanning line according to the offset angle and the size of sub-pixel units, which scanning unit includes at least one sub-pixel unit;

determining the starting point of each redefined scanning line according to the offset angle and the size of sub-pixel units; and

performing scan display according to the scanning reference point, the distribution of the scanning units and the starting point of the redefined scanning line that are determined.

In some embodiments, the offset between the display panel and the cover plate is an offset of the alignment angle of the display panel and the cover plate, and the geometric centers of the display panel and the cover plate have no offset and coincide.

In some embodiments, both the cover plate and the display panel have a circular shape and the centers of the two coincide.

In some embodiments, the determining a scanning reference point (x2, y2) according to an offset angle includes:

determining the scanning reference point according to the following formula

$$x 2 = x 1 [ 1 + \sqrt{2 - 2 cos β} ( cos \frac{β}{2} - sin \frac{β}{2} ) ]$$

$$y 2 = y 1 [ 1 + \sqrt{2 - 2 cos β} ( cos \frac{β}{2} + sin \frac{β}{2} ) ]$$

wherein x1 and y1 are the abscissa and the ordinate of an original scanning reference point of the display panel, respectively, and β is the offset angle.

In some embodiments, the individual sub-pixel units of the display panel are arranged in a matrix, and the determining a scanning unit according to the offset angle and the size of sub-pixel units includes:

determining the number M of sub-pixel units in each scanning unit according to the following formula:

M=a÷(tan β×b)

wherein a is the height of a sub-pixel unit, b is the width of the sub-pixel unit, and β is the offset angle, and wherein M is a positive integer; and

determining each scanning unit according to the determined number of sub-pixel units in each scanning unit and a matrix row of the matrix.

In some embodiments, the determining each scanning unit according to the determined number of sub-pixel units in each scanning unit and a matrix row of the matrix includes: arranging the M sub-pixel units in sequence according to the matrix row of the matrix, wherein different scanning units do not share the same sub-pixel unit.

In some embodiments, in a case in which it is observed in a direction from the cover plate to the display panel that the cover plate is offset clockwise relative to the display panel, the determining the distribution of individual scanning units in a redefined scanning line according to the offset angle and the size of sub-pixel units includes:

determining the redefined scanning line in the following way: if the i-th scanning unit in the redefined scanning line is located in the j-th matrix row of the matrix, then the (i+1)-th scanning unit in the redefined scanning line is located in the (j+1)-th matrix row of the matrix and the previous scanning unit is connected end to end with the next scanning unit, wherein i and j are positive integers.

In some embodiments, in a case in which it is observed in a direction from the cover plate to the display panel that the cover plate is offset counterclockwise relative to the display panel, the determining the distribution of individual scanning units in a redefined scanning line according to the offset angle and the size of sub-pixel units includes:

determining the redefined scanning line in the following way: if the i-th scanning unit in the redefined scanning line is located in the j-th matrix row of the matrix, then the (i+1)-th scanning unit in the redefined scanning line is located in the (j−1)-th matrix row of the matrix and the previous scanning unit is connected end to end with the next scanning unit, wherein i is a positive integer and j is a positive integer greater than or equal to 2.

In some embodiments, the determining the starting point of each redefined scanning line according to the offset angle and the size of sub-pixel units includes:

determining the number N of line scanning starting points located in the same column according to the following formula

N=b÷(tan β×a)

wherein a is the height of sub-pixel units, b is the width of sub-pixel units, and β is the offset angle, and wherein N is a positive integer; and

determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l+1)-th matrix column of the matrix, wherein k and l are positive integers.

In some embodiments, the determining the starting point of each redefined scanning line according to the offset angle and the size of sub-pixel units includes:

determining the number N of line scanning starting points located in the same column according to the following formula

N=b÷(tan β×a)

wherein a is the height of sub-pixel units, b is the width of sub-pixel units, and β is the offset angle, and wherein N is a positive integer; and

determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l−1)-th matrix column of the matrix, wherein k is a positive integer and l is a positive integer greater than or equal to 2.

In some embodiments, when both k and i are 1, the first starting point is the first sub-pixel unit of the first scanning unit, wherein the first sub-pixel unit of the first scanning unit refers to one of at least one sub-pixel unit included in the first scanning unit and arranged in sequence along a matrix row, which is closest to the scanning reference point.

According to a second aspect, there is provided a display device, wherein the display device includes a cover plate and a display panel, there is an offset between the cover plate and the display panel, and the offset is modified according to a scanning modification method as described above.

### BRIEF DESCRIPTION OF THE DRAWINGS

Other features, objects and advantages of this application will become more apparent by reading a detailed description of non-limiting embodiments made with reference to the following drawings:

FIG. 1 shows an exemplary flow chart of a scanning modification method of a display panel according to an embodiment of this application;

FIG. 2 shows a specific exemplary diagram of a step S101 in the scanning modification method of the display panel in FIG. 1;

FIG. 3 shows a specific exemplary diagram of a step S102 and a step S103 in the scanning modification method of the display panel in FIG. 1; and

FIG. 4 shows another specific exemplary diagram of the step S102 and the step S103 in the scanning modification method of the display panel in FIG. 1.

### DETAILED DESCRIPTION

In the following the application will be further described in detail in conjunction with the drawings and embodiments. It may be appreciated that the specific embodiments described herein are merely used for explaining the related invention, but not limiting the invention. In addition, it further needs to be noted that only those parts related with the invention are shown in the drawings for the convenience of description.

Unless otherwise defined, the technical terminology or the scientific terminology used in the disclosure should have the general meanings understood by the person having general skills in the art that the invention belongs to. The “first”, “second” and similar words used in the disclosure do not mean any order, number or importance, but are just used to differentiate between different constituent parts. The word “include” or “including” or the like means that an element or article preceding the word encompasses the element or article listed behind the word and the equivalent thereof, without excluding other elements or articles. The word “connection” or “connected” or the like is not limited to a physical or mechanical connection, but may include an electrical connection, whether it is direct or indirect. The “up”, “down”, “left”, or “right”, etc. is just used for denoting a relative position relationship, and when the absolute position of a described object changes, the relative position relationship may also change correspondingly.

It needs to be noted that, in the absence of conflict, the embodiments in this application and the features in the embodiments may be combined with each other. In the following, the application will be described in detail with reference to the drawings and in conjunction with the embodiments.

The inventors have found that, currently, cover plates of many display devices are marked with a time scale or pointer characters, which should correspond to a time scale or pointer characters shown by display panels. Thus, it is required for a cover plate to be capable of being accurately aligned with a display panel when the cover plate is bonded, so as to ensure that the scale of the cover plate corresponds to the scale shown on the display panel. However, in actual production, there are often some situations in which there is an offset in the cover plate alignment. Once the offset takes place and cannot be adjusted by mechanical rotation due to a greater bonding force between the cover plate and the display panel, it will cause defective products of the display device and result in huge yield loss and waste of resources.

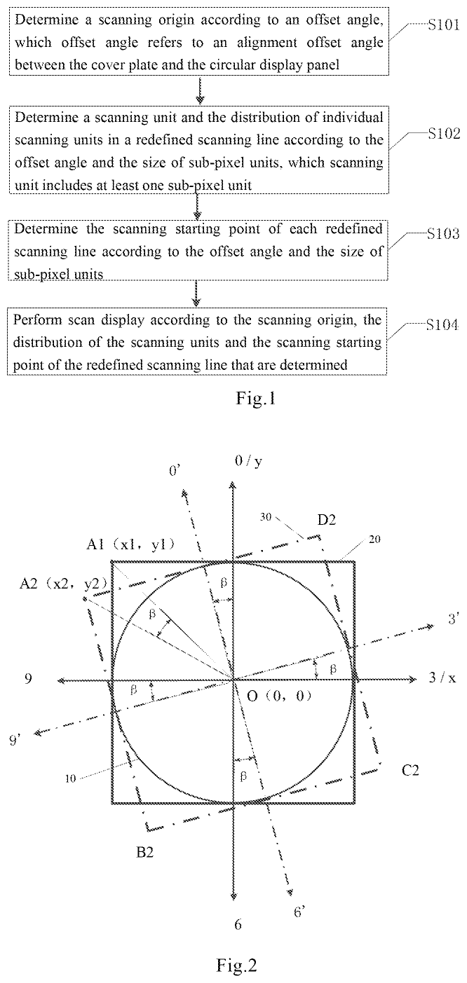

In order to solve the above problem of alignment offset between the display panel and the cover plate, this application proposes a scanning modification method for modifying an offset between a display panel and a cover plate. Reference is made to FIG. 1, which gives an exemplary flow chart of the scanning modification method of the display panel. As shown in FIG. 1, the scanning modification method includes the following steps:

step S101, determining a scanning reference point according to an offset angle, which offset angle refers to an alignment offset angle between the cover plate and the display panel;

step S102, determining a scanning unit and the distribution of individual scanning units in a redefined scanning line according to the offset angle and the size of sub-pixel units, which scanning unit includes at least one sub-pixel unit;

step S103, determining the starting point of each redefined scanning line according to the offset angle and the size of sub-pixel units; and

step S104, performing scan display according to the scanning reference point, the distribution of the scanning units and the starting point of the redefined scanning line that are determined.

The individual sub-pixel units in the display panel are arranged in a matrix, and conventional line-by-line scanning may be employed to implement image display. After an offset occurs between the cover plate and the display panel, it will result in a problem that the scale of the cover plate does not correspond to the scale shown on the display panel if the existing line-by-line scanning mode is still adopted. This application performs modification by adjusting the existing scanning method, such that the scale of the cover plate corresponds to that shown on the display panel. In the description of this disclosure, the offset between the display panel and the cover plate is an offset of the alignment angle of the display panel and the cover plate, and the geometric centers of the display panel and the cover plate have no offset and coincide. For example, both the cover plate and the display panel have a circular shape and the centers of the two coincide, however, there occurs an offset of the alignment angle for scale lines of the two which should have corresponded to each other.

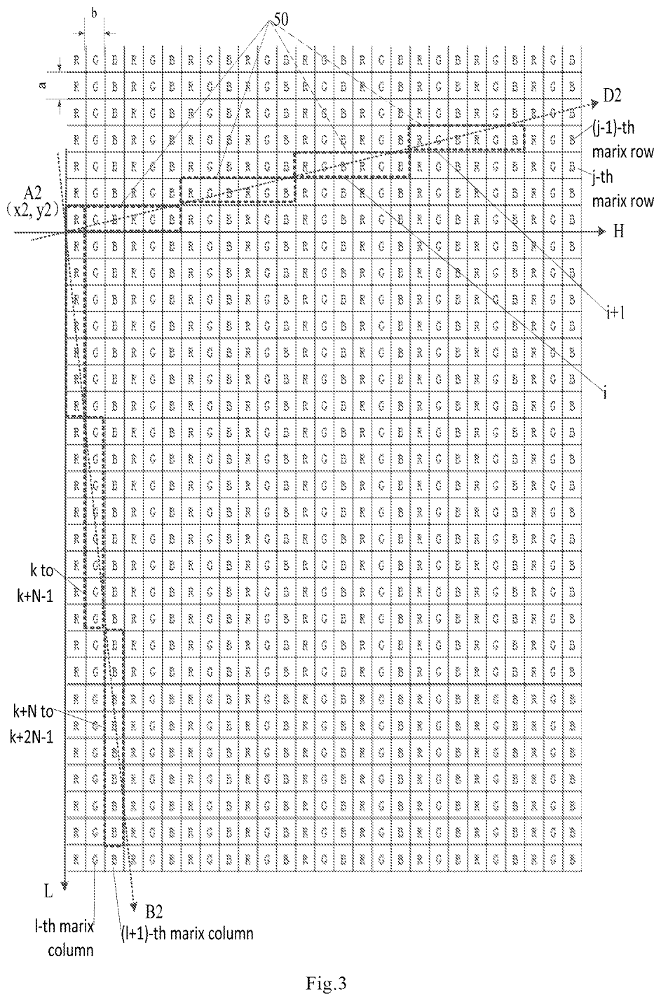

In the following, a specific description will be given in conjunction with FIG. 2 and FIG. 3. FIG. 2 shows a specific exemplary diagram of the step S101 in the scanning modification method of the circular display panel in FIG. 1, and FIG. 3 shows a specific exemplary diagram of the step S102 and the step S103 in the scanning modification method of the circular display panel in FIG. 1.

In some embodiments, at the step S101, it is needed to determine the scanning reference point A2 according to the offset angle. As shown in FIG. 2, therein, the circular display panel 10 to which the offset does not occur is scanned by way of a rectangle, and the side length of the corresponding rectangle 20 is equal to the length of the diameter of the circular display panel. It may be appreciated that although the scanning is done by way of the rectangle 20, display of a circle can be achieved by writing display data of corresponding columns of the circle.

For the convenience of illustration, a watch is taken as an example for explanation. The cover plate is marked with scale lines such as 0 o'clock, 3 o'clock, 6 o'clock and 9 o'clock, solid lines represent scale lines shown on the display panel, and dotted lines represent scale lines on the cover plate to which the offset occurs. At this point, there is an offset angle β between the scale of the cover plate and the scale of the display panel, which is manifested as that the scale lines of 0 o'clock, 3 o'clock, 6 o'clock, 9 o'clock of the display panel and the scale lines of 0′ o'clock, 3′ o'clock, 6′ o'clock, 9′ o'clock of the cover plate have an offset angle β, respectively. Therefore, it is needed to modify the original scanning mode based on the rectangle 20 into a scanning mode corresponding to a rectangle 30 by changing the scanning mode, wherein the rectangle 30 includes four vertices A2, B2, C2 and D2. At this point, the scanning reference point A1 (x1, y1) is changed to the scanning reference point A2 (x2, y2). It may be appreciated that this scanning reference point is used for determining the starting position of the first scanning line of the rectangle. In this embodiment, the circle center of the display panel is set to the coordinate origin O, the scale line of 3 o'clock is set to the x axis, the scale line of 0 o'clock is set to the y axis, and the angle between the line OA1 and the line OA2 is equal to the offset angle β. Then, it may be such that the coordinates of the scanning reference point A2 (x2, y2) are determined according to the scanning reference point A1 (x1, y1), the offset angle β and the geometric relationship by the following formula:

$$x 2 = x 1 [ 1 + \sqrt{2 - 2 cos β} ( cos \frac{β}{2} - sin \frac{β}{2} ) ]$$

$$y2 = y 1 [ 1 + \sqrt{2 - 2 cos β} ( cos \frac{β}{2} + sin \frac{β}{2} ) ]$$

wherein x1, y1 are the abscissa and the ordinate of the original scanning reference point of the display panel, respectively.

In some embodiments, at the step S102, the individual sub-pixel units of the display panel are arranged in a matrix, and the determining a scanning unit according to the angle and the size of sub-pixel units includes:

determining the number M of sub-pixel units in each scanning unit according to the following formula:

M=a÷(tan β×b)

wherein a is the height of a sub-pixel unit, b is the width of the sub-pixel unit, and β is the offset angle, and wherein M is a positive integer; and

determining each scanning unit according to the determined number of sub-pixel units in each scanning unit and a matrix row of the matrix.

As shown in FIG. 3, the sub-pixel units are arranged in a matrix, the matrix is divided into matrix rows and matrix columns, and display is conducted by scanning line by line according to matrix rows when scanning modification is not performed. In some embodiments, a modified scanning line corresponding to the rectangle 30 is arranged along the line A2D2 and not in the same matrix row. For differentiation, a modified scanning line corresponding to the rectangle 30 is called a redefined scanning line. From the graphic geometric relationship, it may be learned that the included angle between the line A2D2 and the line A2H equals the offset angle β, and the line A2H is parallel to the x axis. The redefined scanning line includes multiple scanning units 50 arranged along the line A2D2, each scanning unit 50 includes M sub-pixel units, and the number M of the sub-pixel units may be determined by the following formula:

M=a÷(tan β×b)

wherein a is the height of a sub-pixel unit, b is the width of the sub-pixel unit, and β is the offset angle, and wherein M is a positive integer.

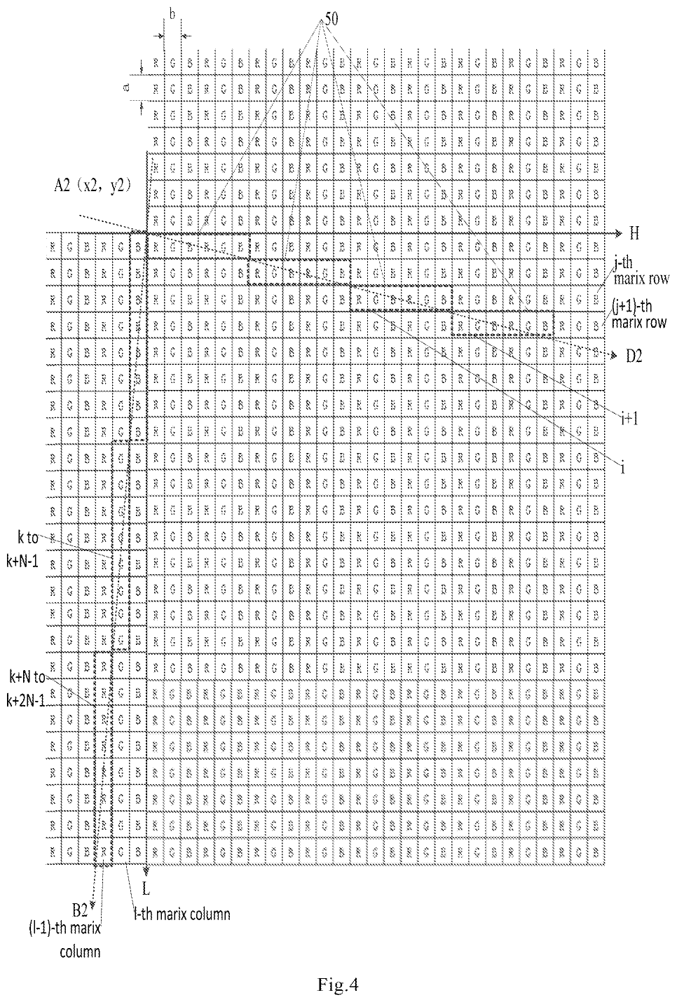

In some embodiments, each scanning unit 50 is determined according to the determined number M of sub-pixel units in each scanning unit and a matrix row of the matrix. For example, as shown in FIG. 3 to FIG. 4, each scanning unit 50 includes M sub-pixel units. The determining each scanning unit 50 according to the determined number M of sub-pixel units in each scanning unit and a matrix row of the matrix may include: arranging the M sub-pixel units in sequence according to the matrix row of the matrix, wherein different scanning units 50 do not share the same sub-pixel unit.

In some embodiments, the offset angle may include two offset directions. One is such that it is observed in a direction from the cover plate to the display panel that the cover plate is offset counterclockwise relative to the display panel, that is, the scale line of 0′ o'clock of the cover plate is to the left of the scale line of 0 o'clock of the display panel. The other is such that it is observed in a direction from the cover plate to the display panel that the cover plate is offset clockwise relative to the display panel, that is, the scale line of 0′ o'clock of the cover plate is to the right of the scale line of 0 o'clock of the display panel. This will be explained in the following, respectively.

In some embodiments, in a case in which it is observed in a direction from the cover plate to the display panel that the cover plate is offset counterclockwise relative to the display panel, the determining the distribution of individual scanning units in a redefined scanning line according to the offset angle and the size of sub-pixel units includes: determining the redefined scanning line in the following way: if the i-th scanning unit in the redefined scanning line is located in the j-th matrix row of the matrix, then the (i+1)-th scanning unit in the redefined scanning line is located in the (j−1)-th matrix row of the matrix and the previous scanning unit is connected end to end with the next scanning unit, wherein i is a positive integer and j is a positive integer greater than or equal to 2.

As shown in FIG. 3, the sub-pixel units of each scanning unit 50 are arranged in a matrix row. Individual scanning units in a redefined scanning line are disposed end to end in the matrix, and meet the following relationship: if the i-th scanning unit in the redefined scanning line is located in the j-th matrix row of the matrix, then the (i+1)-th scanning unit in the redefined scanning line is located in the (j−1)-th matrix row of the matrix and the previous scanning unit is connected end to end with the next scanning unit, wherein i is a positive integer and j is a positive integer greater than or equal to 2. As shown in FIG. 3, the (i+1)-th scanning unit is located in a matrix row previous to the i-th scanning unit, that is, the i-th scanning unit and the (i+1)-th scanning unit are arranged in an offset direction A2D2 of the offset angle. In particular, the individual scanning units in the redefined scanning line are arranged along the line A2D2, the included angle between the line A2D2 and the line A2H is the offset angle 13, and the line A2H is parallel to the x axis. Likewise, individual scanning units in a next redefined scanning line are arranged along a line parallel to the line A2D2. At this point, it is observed in a direction from the cover plate to the display panel that the cover plate is offset counterclockwise relative to the display panel, namely, the scale line of 0′ o'clock of the cover plate is to the left of the scale line of 0 o'clock of the display panel.

As shown in FIG. 3, in some embodiments, the determining the starting point of each redefined scanning line according to the offset angle and the size of sub-pixel units includes:

determining the number N of line scanning starting points located in the same column according to the following formula

N=b÷(tan β×a)

wherein a is the height of sub-pixel units, b is the width of sub-pixel units, and β is the offset angle, and wherein N is a positive integer; and determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l+1)-th matrix column of the matrix, wherein k and l are positive integers.

As shown in FIG. 3, after the offset occurs, the position of the starting point of each redefined scanning line is not in the line of the same matrix column A2L, there will be a dislocation, and the number N of redefined scanning lines of which the starting points are in the same column is equal, whose calculation formula is as follows:

N=b÷(tan β×a)

wherein a is the height of sub-pixel units, b is the width of sub-pixel units, and β is the offset angle.

At this point, as shown in FIG. 3, if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l+1)-th matrix column of the matrix, wherein k and l are positive integers. The starting points of multiple redefined scanning lines are arranged along the offset direction as a whole, that is, the starting points of different sets of redefined scanning lines are arranged along the line A2B2 as a whole, the included angle between the line A2B2 and the line A2L is the offset angle β, and the line A2L is parallel to the y axis. At this point, it is observed in a direction from the cover plate to the display panel that the cover plate is offset counterclockwise relative to the display panel.

On the contrary, in a case in which it is observed in a direction from the cover plate to the display panel that the cover plate is offset clockwise relative to the display panel, as shown in FIG. 4, the determining the distribution of individual scanning units in a redefined scanning line according to the offset angle and the size of sub-pixel units includes:

arranging individual sub-pixel units in each scanning unit in a single row side by side; and

determining the redefined scanning line in the following way: if the i-th scanning unit in the redefined scanning line is located in the j-th matrix row of the matrix, then the (i+1)-th scanning unit in the redefined scanning line is located in the (j+1)-th matrix row of the matrix and the previous scanning unit is connected end to end with the next scanning unit, wherein 1 and j are positive integers.

Exemplarily, the sub-pixel units in each scanning unit 50 are arranged in a matrix row. Individual scanning units in a redefined scanning line are disposed end to end in the matrix and meet the following relationship: if the i-th scanning unit in the redefined scanning line is located in the j-th matrix row of the matrix, then the (i+1)-th scanning unit in the redefined scanning line is located in the (j+1)-th matrix row of the matrix and the previous scanning unit is connected end to end with the next scanning unit, wherein i and j are positive integers. As shown in FIG. 4, the (i+1)-th scanning unit is located in a matrix row next to the i-th scanning unit, that is, the i-th scanning unit and the (i+1)-th scanning unit are arranged along the offset direction A2D2. In particular, the individual scanning units in the redefined scanning line are arranged along the line A2D2, the included angle between the line A2D2 and the line A2H is the offset angle β, and the line A2H is parallel to the x axis. Likewise, individual scanning units in a next redefined scanning line are arranged along a parallel line of the line A2D2.

As shown in FIG. 4, in some embodiments, the determining the starting point of each redefined scanning line according to the offset angle and the size of sub-pixel units includes:

determining the number N of line scanning starting points located in the same column according to the following formula

N=b÷(tan β×a)

wherein a is the height of sub-pixel units, b is the width of sub-pixel units, and β is the offset angle, and wherein N is a positive integer; and determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l−1)-th matrix column of the matrix, wherein k is a positive integer and l is a positive integer greater than or equal to 2.

As shown in FIG. 4, after the offset occurs, the position of the starting point of each redefined scanning line is not in the same matrix column A2L, there will be a dislocation, and the number N of redefined scanning lines of which the starting points are in the same column is equal, whose calculation formula is as follows:

N=b÷(tan β×a)

wherein a is the height of sub-pixel units, b is the width of sub-pixel units, and β is the offset angle.

At this point, as shown in FIG. 4, if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l−1)-th matrix column of the matrix, wherein k is a positive integer and l is a positive integer greater than or equal to 2. The starting points of multiple redefined scanning lines are arranged along the offset direction as a whole, that is, the starting points of different sets of redefined scanning lines are arranged along the line A2B2 as a whole, the included angle between the line A2B2 and the line A2L is the offset angle 13, and the line A2L is parallel to the y axis. At this point, it is observed in a direction from the cover plate to the display panel that the cover plate is offset clockwise relative to the display panel.

In some embodiments, as shown in FIG. 3 to FIG. 4, when both k and i are 1, the first starting point may coincide with the first sub-pixel unit of the first scanning unit, i.e., the first starting point may be the first sub-pixel unit of the first scanning unit, wherein the first sub-pixel unit of the first scanning unit refers to one of at least one sub-pixel unit included in the first scanning unit and arranged in sequence along a matrix row, which is closest to the scanning reference point (x2, y2).

At the step 104, scan display is performed according to the scanning reference point, the distribution of redefined scanning lines and the starting point of each redefined scanning line that are determined above, and thereby the offset between the display panel and the cover plate can be solved.

This application further provides a display device, the display device includes a cover plate and a display panel, there is an offset between the cover plate and the display panel, and the offset is modified according to a scanning modification method as described above

According to the technical solution provided by the embodiments of this application, a scanning reference point is determined according to an offset angle; according to the offset angle and the size of sub-pixel units, a scanning unit and the distribution of individual scanning units in a redefined scanning line are determined, which scanning unit includes at least one sub-pixel unit, and the starting point of each redefined scanning line is determined; and scan display is performed according to the scanning reference point, the distribution of the scanning units and the starting point of the redefined scanning line that are determined, which can solve the problem of alignment offset between the cover plate and the display panel.

The foregoing description is just the preferable embodiments of this application and the illustration of the applied technical principles. It should be appreciated by the person having ordinary skills in the art that the scope of the invention covered in this application is not limited to technical solutions formed by specific combinations of the above technical features, and at the same time, should also encompass other technical solutions formed by any combinations of the above technical features or their equivalent features, without departing from the concepts of the invention, for example, technical solutions formed by the above features and technical features (not limited thereto) disclosed in the application and having similar functions replacing each other.

1. A scanning modification method for modifying an offset between a display panel and a cover plate, wherein the method includes:
determining a scanning reference point according to an offset angle, which offset angle refers to an alignment offset angle between the cover plate and the display panel;
determining a scanning unit and the distribution of individual side scanning units in a redefined scanning line according to the offset angle and the size of sub-pixel units, which scanning unit includes at least one sub-pixel unit;
determining the starting point of each said redefined scanning line according to the offset angle and the size of sub-pixel units; and
performing scan display according to the scanning reference point, the distribution of the scanning units and the starting point of the redefined scanning line that are determined.

2. The scanning modification method as claimed in claim 1, wherein the offset between the display panel and the cover plate is an offset of the alignment angle of the display panel and the cover plate, and the geometric centers of the display panel and the cover plate have no offset and coincide.

3. The scanning modification method as claimed in claim 2, wherein both the cover plate and the display panel have a circular shape and the centers of the two coincide.

4. The scanning modification method as claimed in claim 3, wherein the determining a scanning reference point (x2, y2) according to an offset angle includes:
determining the scanning reference point according to the following formula
$$x 2 = x 1 [ 1 + \sqrt{2 - 2 cos β} ( cos \frac{β}{2} - sin \frac{β}{2} ) ]$$
$$y 2 = y 1 [ 1 + \sqrt{2 - 2 cos β} ( cos \frac{β}{2} + sin \frac{β}{2} ) ]$$
wherein x1 and y1 are the abscissa and the ordinate of an original scanning reference point of the display panel, respectively, and β is the offset angle.

5. The scanning modification method as claimed in claim 3, wherein the individual sub-pixel units of the display panel are arranged in a matrix, and the determining a scanning unit according to the offset angle and the size of sub-pixel units includes:
determining the number M of sub-pixel units in each scanning unit according to the following formula:
M=a÷(tan β×b)
wherein a is the height of a sub-pixel unit, b is the width of the sub-pixel unit, and β is the offset angle, and wherein M is a positive integer; and
determining each scanning unit according to the determined number of sub-pixel units in each scanning unit and a matrix row of the matrix.

6. The scanning modification method as claimed in claim 5, wherein the determining each scanning unit according to the determined number of sub-pixel units in each scanning unit and a matrix row of the matrix includes:
arranging the M sub-pixel units in sequence according to the matrix row of the matrix,
wherein different scanning units do not share the same sub-pixel unit.

7. The scanning modification method as claimed in claim 6, wherein in a case in which it is observed in a direction from the cover plate to the display panel that the cover plate is offset clockwise relative to the display panel, the determining the distribution of individual said scanning units in a redefined scanning line according to the offset angle and the size of sub-pixel units includes:
determining the redefined scanning line in the following way: if the i-th scanning unit in the redefined scanning line is located in the j-th matrix row of the matrix, then the (i+1)-th scanning unit in the redefined scanning line is located in the (j+1)-th matrix row of the matrix and the previous scanning unit is connected end to end with the next scanning unit, wherein i and j are positive integers.

8. The scanning modification method as claimed in claim 6, wherein in a case in which it is observed in a direction from the cover plate to the display panel that the cover plate is offset counterclockwise relative to the display panel, the determining the distribution of individual said scanning units in a redefined scanning line according to the offset angle and the size of sub-pixel units includes:
determining the redefined scanning line in the following way: if the i-th scanning unit in the redefined scanning line is located in the j-th matrix row of the matrix, then the (i+1)-th scanning unit in the redefined scanning line is located in the (j−1)-th matrix row of the matrix and the previous scanning unit is connected end to end with the next scanning unit, wherein i is a positive integer and j is a positive integer greater than or equal to 2.

9. The scanning modification method as claimed in claim 8, wherein the determining the starting point of each said redefined scanning line according to the offset angle and the size of sub-pixel units includes:
determining the number N of line scanning starting points located in the same column according to the following formula
N=b÷(tan β×a)
wherein a is the height of sub-pixel units, b is the width of sub-pixel units, and β is the offset angle, and wherein N is a positive integer; and
determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l+1)-th matrix column of the matrix, wherein k and l are positive integers.

10. The scanning modification method as claimed in claim 7, wherein the determining the starting point of each said redefined scanning line according to the offset angle and the size of sub-pixel units includes:
determining the number N of line scanning starting points located in the same column according to the following formula
N=b÷(tan β×a)
wherein a is the height of sub-pixel units, b is the width of sub-pixel units, and β is the offset angle, and wherein N is a positive integer; and
determining the starting point of each redefined scanning line in the following way: if the k- to (k+N−1)-th starting points corresponding to different redefined scanning lines are located in the 1-th matrix column of the matrix, then the (k+N)- to (k+2N−1)-th starting points corresponding to different redefined scanning lines are located in the (l−1)-th matrix column of the matrix, wherein k is a positive integer and l is a positive integer greater than or equal to 2

11. The scanning modification method as claimed in claim 9, wherein when both k and i are 1, the first starting point is the first sub-pixel unit of the first scanning unit, wherein the first sub-pixel unit of the first scanning unit refers to one of at least one sub-pixel unit included in the first scanning unit and arranged in sequence along a matrix row, which is closest to the scanning reference point

12. The scanning modification method as claimed in claim 10, wherein when both k and i are 1, the first starting point is the first sub-pixel unit of the first scanning unit, wherein the first sub-pixel unit of the first scanning unit refers to one of at least one sub-pixel unit included in the first scanning unit and arranged in sequence along a matrix row, which is closest to the scanning reference point

13. A display device, wherein the display device includes a cover plate and a display panel, there is an offset between the cover plate and the display panel, and the offset is modified according to the scanning modification method as claimed in claim 1.
